(19) United States
(12) Patent Application Publication
(10) Pub. No.: US 2017/0355319 A1
(43) Pub. Date: Dec. 14, 2017

(54) INTEGRATED LADDER RACK FOR A TRUCK

(71) Applicant: FORD GLOBAL TECHNOLOGIES, LLC, Dearborn, MI (US)

(72) Inventor: Pattrick Loew, Dearborn, MI (US)

(21) Appl. No.: 15/179,450

(22) Filed: Jun. 10, 2016

(51) Int. Cl. B60R 9/048

(52) U.S. Cl. CPC B60R 9/0485

(57) ABSTRACT

An integrated ladder rack is provided for a truck. That integrated ladder rack includes a first side frame, a second side frame, a first cross member and a second cross member. The first side frame and the second side frame are translated from a stowed position to a deployed position and the first cross member and the second cross member are displaced to span between the deployed side frames to form a ladder rack. The related method is also disclosed.

### TECHNICAL FIELD

This document relates generally to the motor vehicle equipment field and, more particularly, to a ladder rack that may be integrated into the truck body so as to be deployable when desired to support a ladder or other elongated object over the load bed and cab of the truck.

### BACKGROUND

Ladder racks have long been provided on flat bed and pickup trucks to allow long objects such as ladders to be carried on the ladder rack above the load bed and cab of the truck.

Semi-permanent ladder racks may be secured to the body or frame of the truck for this purpose. However, the cross members of such a ladder rack may interfere with carrying certain cargo items including, particularly, items that are taller than the clearance space provided between the rear cross member of the ladder rack and the upper surface of the load bed of the truck. In such a situation, one must detach the cross member in order to carry the item. This is an inconvenient and sometimes time-consuming task wasting valuable time that might be spent on other matters. Thus, the attaching and detaching of a semi-permanent ladder rack is a drain on productivity.

This document relates to a new and improved integrated ladder rack that is integrated with the body of the truck and may be quickly and easily stowed or deployed as necessary for properly and effectively managing substantially any cargo application.

### SUMMARY

In accordance with the purposes and benefits described herein, an integrated ladder rack is provided for a truck such as a pickup truck. That ladder rack comprises a first side frame, a second side frame, a first cross member and a second cross member. The first side frame and the second side frame are translated from a stowed position within the opposing load bed side walls of the truck to a deployed position where they are raised above those side walls. Further, the first cross member and the second cross member are displaced to span between the first side frame and the second side frame so as to form the ladder rack.

The first side frame may include a first top member while the second side frame may include a second top member. A first hinge may be provided to pivotally connect the first cross member to the first top member. A second hinge may be provided to pivotally connect the second cross member to the second top member.

The first top member may include a first channel and the first cross member may be received and held in that first channel when the first cross member is in a home position. Similarly, the second top member may include a second channel and the second cross member may be received and held in that second channel when the second cross member is in a home position.

A first lock may be provided for holding the first cross member in the first channel. Similarly, a second lock may be provided for holding the second cross member in the second channel.

A first compartment may be provided in a first side wall of the truck. That first compartment functions to receive and hold the first side frame when the first side frame is in the stowed position. Similarly, a second compartment may be provided in a second side wall of the truck. The second compartment receives and holds the second side frame when the second side frame is in the stowed position.

A first lift mechanism may be provided for biasing the first side frame toward the deployed position. Similarly, a second lift mechanism may be provided for biasing the second side frame toward the deployed position.

Still further, the integrated ladder rack may include a first latch mechanism for securing the first side frame in either the stowed position or the deployed position. In addition, the integrated ladder rack may include a second latch mechanism for securing the second side frame in either the stowed position or the deployed position.

The first latch mechanism may include a first latch bolt that is received in a first cooperating latch receiver provided in the first side frame when the first side frame is locked in the stowed position or the deployed position. That first latch mechanism may include a first rotary actuator connected to the first latch bolt.

The integrated ladder rack may also include a second latch mechanism including a second latch bolt that is received in the second cooperating latch receiver provided in the second side frame when the second side frame is locked in either the stowed position or the deployed position. The second latch mechanism may also include a secondary rotary actuator connected to the second latch bolt.

In accordance with an additional aspect, a pickup truck is provided incorporating the integrated ladder rack described herein.

In accordance with yet another aspect, a method is provided for deploying a ladder rack on a truck. That method may be described as comprising the steps of: (a) translating a first side frame from a stowed position within a first load bed side wall into a deployed position, (b) translating a second side frame from a stowed position within a second load bed side wall into a deployed position and (c) spanning the deployed first side frame and the deployed second side frame with a first cross member and a second cross member.

More specifically, the method may include the steps of pivoting the first cross member from a home position in a first channel in the first side frame into a spanning position between the first side frame and the second side frame. Further, the method may include the step of pivoting the second cross member from a home position in a second channel in the second side frame into a spanning position between the first side frame and the second side frame.

Still further, the method may include the steps of securing a first distal end of the first cross member to the second side frame and securing a second distal end of the second cross member to the first side frame.

In the following description, there are shown and described several preferred embodiments of the integrated ladder rack and the associated method for deploying a ladder rack on a truck. As it should be realized, the integrated ladder rack and associated method are capable of other, different embodiments and their several details are capable of modification in various, obvious aspects all without departing from the ladder rack and method as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the integrated ladder rack and the associated method and together with the description serve to explain certain principles thereof. In the drawing figures:

FIG. 1 is a perspective view of a pickup truck incorporating the integrated ladder rack and illustrating that integrated ladder rack in the stowed position.

FIG. 2 is a perspective view of the pickup truck illustrated in FIG. 1 and showing the integrated ladder rack in the fully deployed position.

FIGS. 3a-3e are schematic illustrations of the integrated ladder rack and when considered together illustrate the method of deploying the integrated ladder rack on the truck.

FIG. 4a is a detailed end view illustrating how a cross member of the ladder rack is held in a channel of the associated side frame when in a home position.

FIG. 4b is a side elevational view of the structure illustrated in FIG. 4a.

Reference will now be made in detail to the present preferred embodiments of the integrated ladder rack, examples of which are illustrated in the accompanying drawing figures.

### DETAILED DESCRIPTION

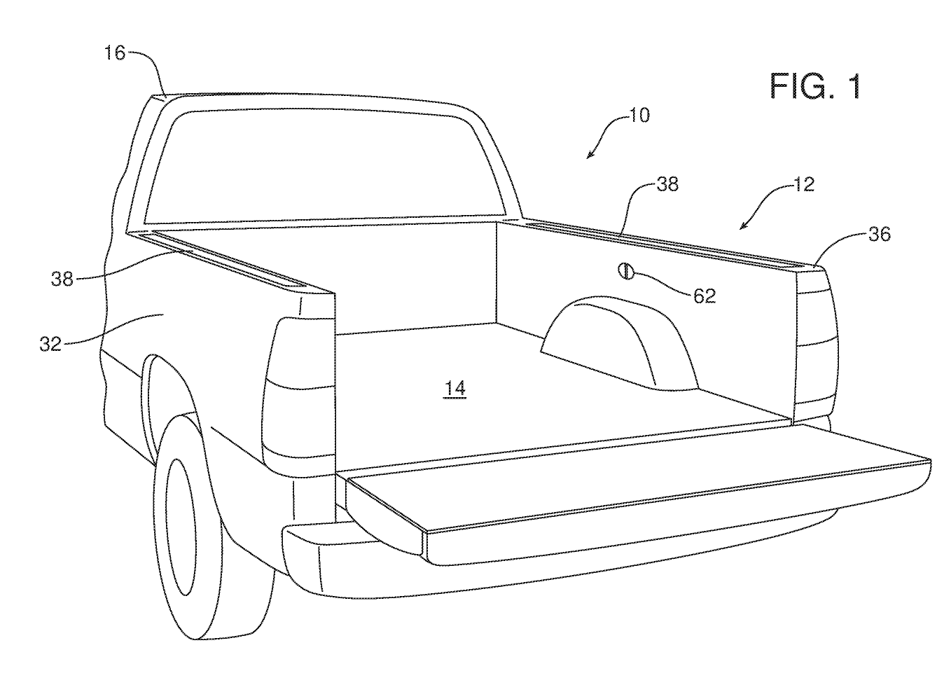

Reference is now made to FIGS. 1-4b illustrating a pickup truck 10 equipped with the integrated ladder rack 12. FIG. 1 shows the pickup truck with the integrated ladder rack 12 in the fully stowed position. Note how the load bed 14 of the pickup truck 10 is completely unencumbered and free to receive cargo. In contrast, when one desires, the integrated ladder rack 12 may be simply and easily deployed to hold longer cargo such as a ladder L above the load bed 14 and the cab 16 of the pickup truck 10.

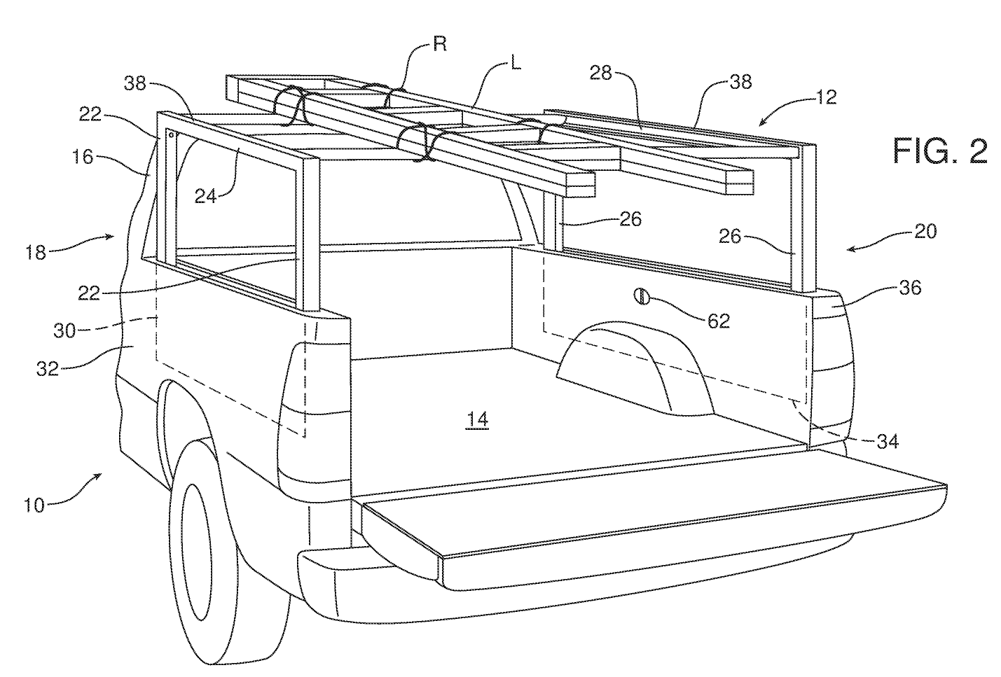

As should be appreciated from reviewing FIGS. 2-4b, the integrated ladder rack 12 includes a first side frame 18 and a second side frame 20.

In the illustrated embodiment, the first side frame 18 includes two vertical posts 22 and a first top member 24 supported at the ends of the posts. Similarly, the second side frame 20 includes two vertical posts 26 and a second top member 28 supported at the ends of the posts.

When in the stowed position, the first side frame 18 is received and held in a first interior compartment 30 within the first load bed side wall 32 of the pickup truck 10. Similarly, when the second side frame 20 is in the stowed position, the second side frame is received within a second compartment 34 within a second load bed side wall 36 of the truck 10.

As should be appreciated from reviewing FIGS. 1, 2, 4a and 4b, each of the first and second top members 24, 28 includes an upper fascia 38 that forms the top wall of the associated truck bed side wall 32, 36 when the side frame 18, 20 is in the stowed position. Underneath the fascia 38 and opening inboard with respect to the pickup truck 10 is a C-shaped channel 40. Thus, it should be appreciated that the first top member 24 includes a first channel 40 and the second top member 28 includes a second channel 42.

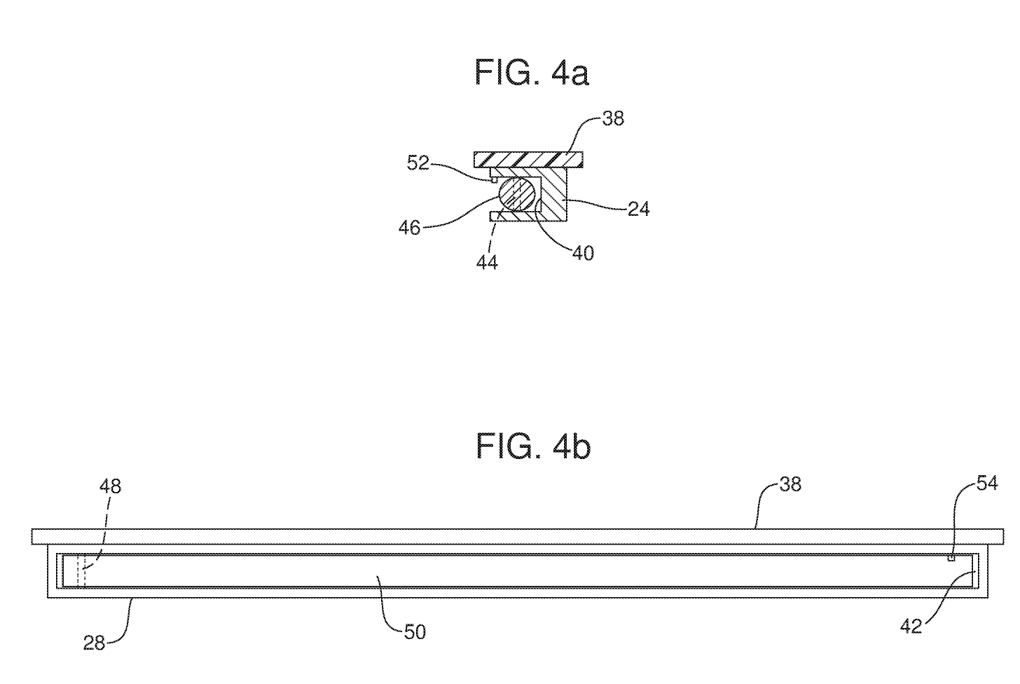

A first hinge 44 pivotally connects the first cross member 46 at a proximal end thereof to the first top member 24. Similarly, a second hinge 48 pivotally connects the second cross member 50 at a proximal end thereof to the second top member 28. When the first cross member 46 is in its home position, the first cross member is received and held in the first channel 40 of the first top member 24. A lock 52, schematically illustrated in FIG. 4a, functions to hold the proximal end of the first cross member in the first channel 40. That lock 52 may comprise any appropriate structure from, for example, a locking feature on the first hinge 44 to a cooperating pin and clip (not shown).

Similarly, when the second cross member 50 is in its home position, the second cross member is received and held in the second channel 42 of the second top member 28. See FIG. 4b. A second lock 54 functions to hold the distal end of the second cross member 50 in the channel 42.

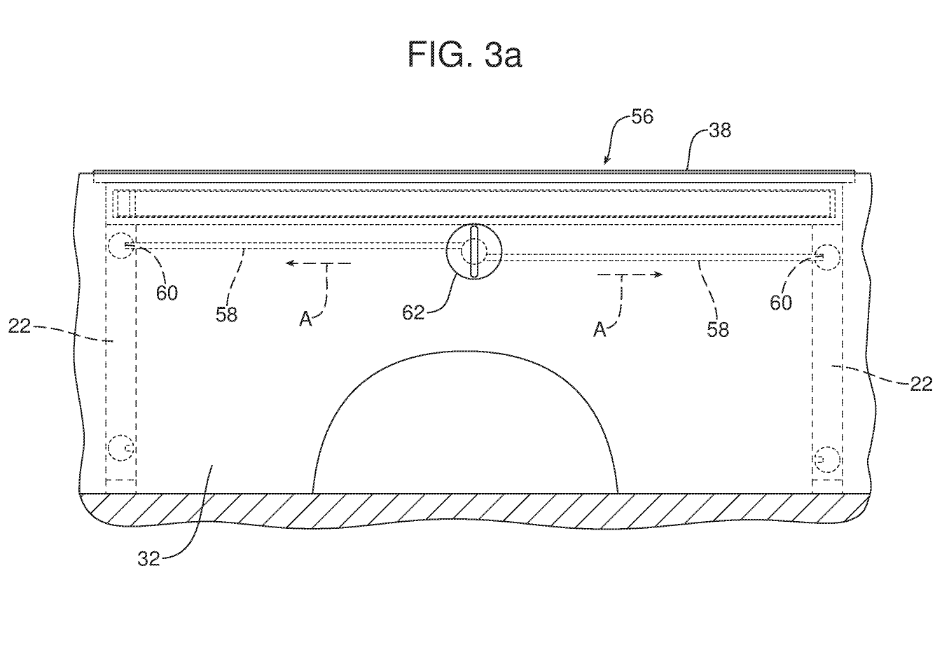

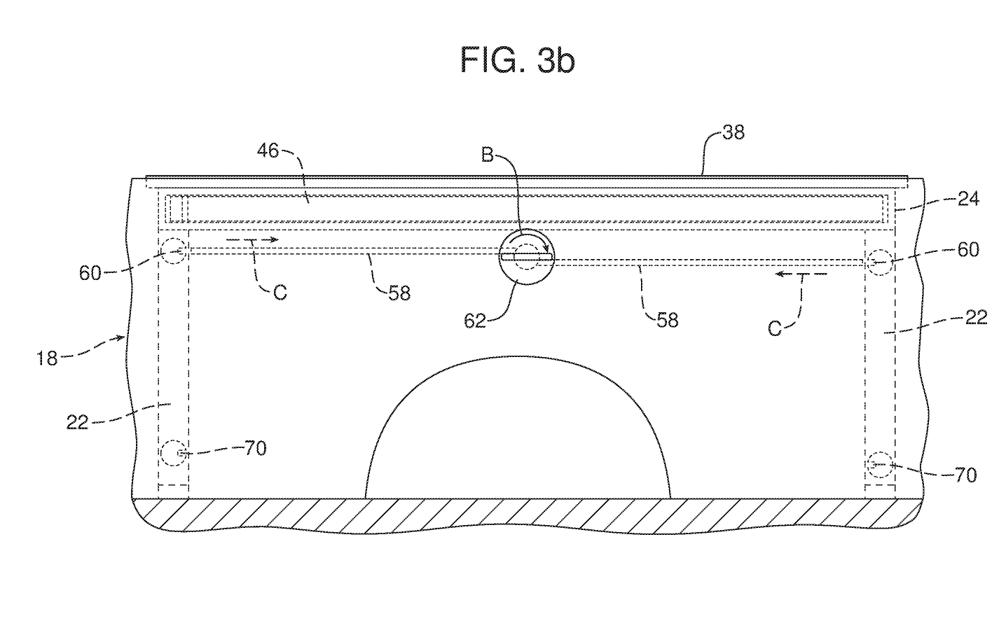

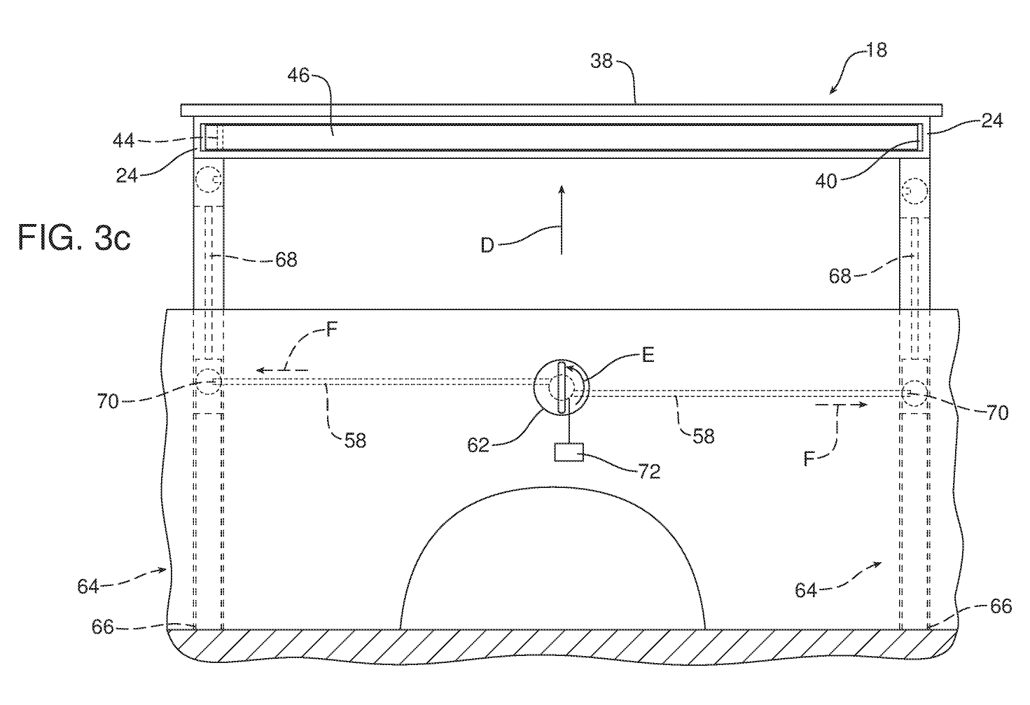

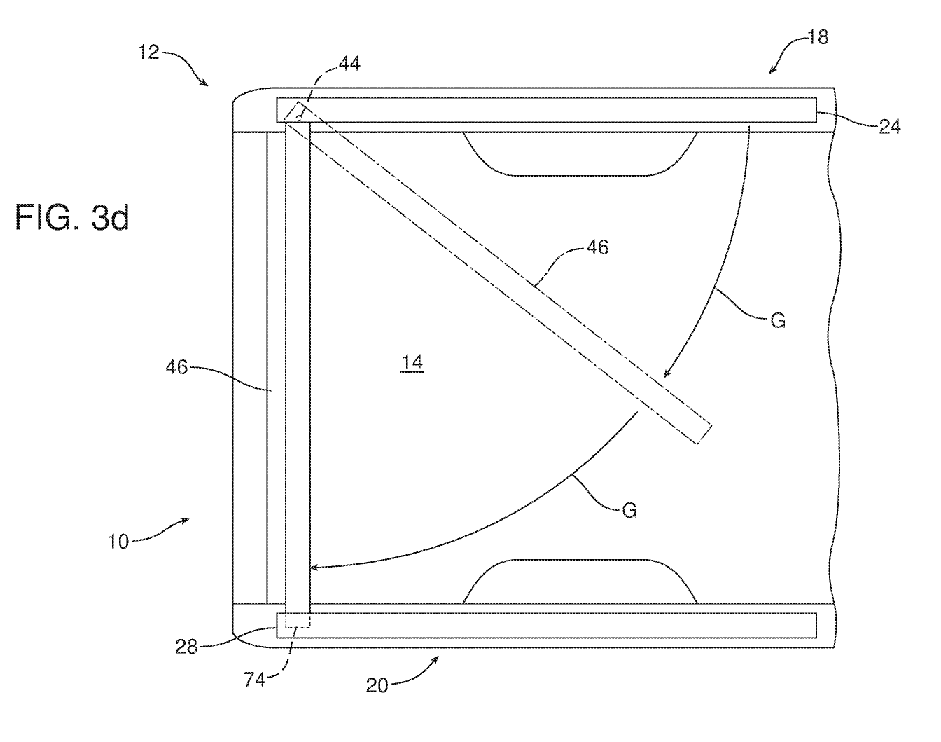

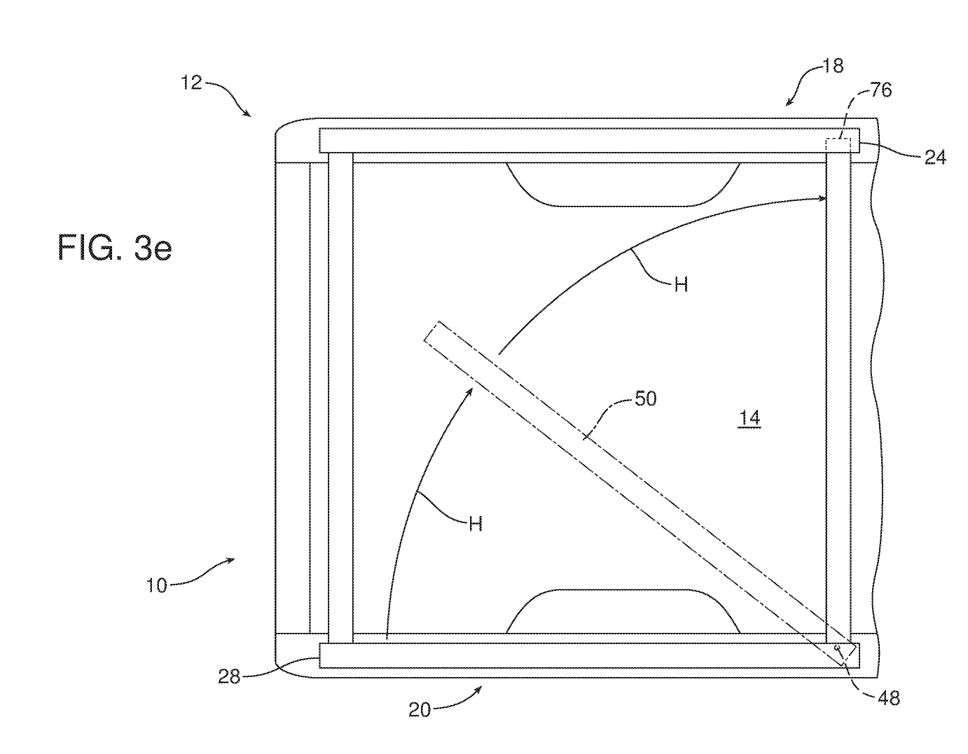

When the integrated ladder rack 12 is in the fully stowed position illustrate in FIG. 1, the first cross member 46 is in its home position within the first channel 40 of the first top member 24 and the first side frame 18 is lowered fully down into the first compartment 30 in the first load bed side wall 32. Similarly, the second cross member 50 is held in its home position within the second channel 42 of the second top member 28 and the second side frame 20 is fully retracted or lowered into the second compartment 34 of the second load bed side wall 36. A first latch mechanism, generally designated by reference numeral 56, secures the first side frame 18 in the stowed position. That first latch mechanism includes a first latch bolt 58 that is received in a first cooperating latch receiver or aperture 60 provided in the two vertical posts 22 of the first side frame 18. A first rotary actuator 62 is connected to the two sections of the latch bolt 58. When the first rotary actuator 62 is rotated into a first, locked position, the two sections of the latch bolt 58 are forced outwardly (note action arrows A in FIG. 3a) so that the distal ends of the two latch bolt sections are received in the two cooperating latch receivers 60: one such latch receiver provided in each post 22.

The integrated ladder rack 12 also includes a second latch mechanism, identical to the first latch mechanism 56, that secures the second side frame 20 in the stowed position. For brevity and simplicity, only the first latch mechanism 56 is described and illustrated in detail.

When one wishes to raise the first side frame 18 from the stowed position illustrated in FIG. 1 to the deployed position illustrated in FIG. 2, one first rotates the rotary actuator 62 to draw the latch bolt sections 58 inward and release the latch bolt 58 from the latch receiver 60. See FIG. 3b and note action arrows B and C. A first lift mechanism, generally designated by reference numeral 64, then functions to bias the first side frame 18 toward the deployed position (note action arrow D in FIG. 3c). In the illustrated embodiment, the first lift mechanism 64 comprises first and second struts having a cylinder end 66 anchored to the truck body at the bottom of the first compartment 30 and a piston end 68 connected to the vertical post 22. For clarity of presentation of other structures, the lift mechanism 64 is illustrated only in FIG. 3c.

In one possible embodiment, the first lift mechanism 64 functions to counter-balance the weight of the first side frame 18 making it easy for an individual to pull (i.e. translate in a vertical direction) the first side frame upward into the fully deployed position illustrated in FIG. 2. At that point the latch bolt 58 is aligned with a second latch receiver 70 in the opposed vertical posts 22 and a spring 72 on the rotary actuator 62 functions to force the latch bolt sections 58 outward into engagement with the latch receiver 70 thereby locking the first side frame 18 in the fully deployed position. Again, see FIG. 3c and note action arrows E and F.

The second side frame 20 is raised and locked in exactly the same manner as the first side frame 18 just as illustrated in FIGS. 3a-3c and as descried above.

Once the two side frames 18, 20 are locked in the fully deployed position, the first cross member 46 is pivoted (note action arrows G) about the first hinge 44 from the home position within the first channel 40 into a spanning position between the first side frame 18 and the second side frame 20. See FIG. 3d. Next, the second cross-member 50 is pivoted (note action arrows H) about the second hinge 48 from the home position within the second channel 40 to a spanning position between the first and second side frames 18, 20. See FIG. 3e. The first distal end 74 of the first cross member 46 is then secured to the second side frame 20 by means a locking pin or other appropriate device (not shown). In addition, the distal end 7b of the second cross member 50 is secured to the first side frame 18 by means of a locking pin or other appropriate device (not shown).

Once the first side frame 18 and second side frame 20 are secured in the fully deployed position by the latch mechanisms 56 and the cross members 46 and 50 are secured in the spanning position by the locking pins, the integrated ladder rack 12 is fully assembled and erected. A ladder L or other elongated object may then be secured to the cross members 46, 50 of the ladder rack 12 by rope, bungee cord or other means R.

The integrated ladder rack 12 may be easily returned to the fully stowed position illustrated in FIG. 1 by first removing the locking pins and then pivoting the two cross members 46 and 50 about the respected hinges 44 and 48 until the distal ends 74, 78 of the respective cross members are held and locked in the respective first and second channels 40, 42 of the respective first and second top members 24, 28. The rotary actuators 62 of the respective latch members 56 are then manipulated to release the latch bolts 58 from the latch receivers 70 and the two side frames 18, 20 are pushed down (i.e. translated in a vertical direction) into the respective first and second compartments 30, 34 until the spring-loaded latch mechanisms 56 engage the latch bolt in the latch receivers 60, thereby locking the first and second side frames 18, 20 in the fully retracted position.

As should be appreciated from the above description, the integrated ladder rack 12 may be quickly and easily erected or stowed depending upon the needs of the vehicle operator. As such the integrated ladder rack 12 described in this document represents a significant improvement in the field of ladder racks for motor vehicles.

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled.

What is claimed:

1. An integrated ladder rack for a truck, comprising:
a first side frame;
a second side frame;
a first cross member; and
a second cross member wherein said first side frame and said second side frame are translated from a stowed position to a deployed position and said first cross member and said second cross member are displaced to span between said first side frame and said second side frame to form a ladder rack.

2. The integrated ladder rack of claim 1, wherein said first side frame includes a first top member and a second side frame includes a second top member.

3. The integrated ladder rack of claim 2, further including a first hinge pivotally connecting said first cross member to said first top member.

4. The integrated ladder rack of claim 3, further including a second hinge pivotally connecting said second cross member to said second top member.

5. The integrated ladder rack of claim 4, wherein said first top member includes a first channel and said first cross member is recessed and held in said first channel when said first cross member is in a first home position.

6. The integrated ladder rack of claim 5, wherein said second top member includes a second channel and said second cross member is received and held in said second channel when said second cross member is in a second home position.

7. The integrated ladder rack of claim 6, further including a first lock holding said first cross member in said first channel and a second lock holding said second cross member in said second channel.

8. The integrated ladder rack of claim 6, further including (a) a first compartment in a first side wall of said truck receiving and holding said first side frame when in said stowed position and (b) a second compartment in a second side wall of said truck receiving and holding said second side frame when in said stowed position.

9. The integrated ladder rack of claim 8, further including a first lift mechanism connected to said first side frame and biasing said first side frame toward said deployed position.

10. The integrated ladder rack of claim 9, further including a second lift mechanism connected to said second side frame and biasing said second side frame toward said deployed position.

11. The integrated ladder rack of claim 10, further including a first latch mechanism securing said first side frame in either said stowed position or said deployed position.

12. The integrated ladder rack of claim 11, further including a second latch mechanism securing said second side frame in either said stowed position or said deployed position.

13. The integrated ladder rack of claim 12, wherein said first latch mechanism includes a first latch bolt that is received in a first cooperating latch receiver provided in said first side frame when said first side frame is locked in said stowed position or said deployed position.

14. The integrated ladder rack of claim 13, wherein said first latch mechanism includes a first rotary actuator connected to said first latch bolt.

15. The integrated ladder rack of claim 14, wherein said second latch mechanism includes a second latch bolt that is received in a second cooperating latch recess provided in said second side frame when said second side frame is locked in said stowed position or said deployed position.

16. The integrated ladder rack of claim 15, wherein said second latch mechanism includes a second rotary actuator connected to said second latch bolt.

17. A pickup truck incorporating the integrated ladder rack of claim 1.

18. A method deploying a ladder rack on a truck, comprising:
translating a first side frame from a stowed position within a first load bed side wall into a deployed position;
translating a second side frame from a stowed position within a second load bed side wall into a deployed position; and
spanning said first side frame and said second side frame with a first cross member and a second cross member.

19. The method of claim 18, including:
pivoting said first cross member from a home position in a first channel in said first side frame into a spanning position between said first side frame and said second side frame; and
pivoting said second cross member from a home position in a second channel in said second side frame into a spanning position between said first side frame and said second side frame.

20. The method of claim 19, including:
securing a first distal end of said first cross member to said second side frame; and
securing a second distal end of said second cross member to said first side frame.
